(19) United States
(12) Patent Application Publication
(10) Pub. No.: US 2009/0132377 A1
(43) Pub. Date: May 21, 2009

(54) Internet protocol-based interstitial advertising

(75) Inventors: Tiffany A. Thompson, Venice, CA (US); Kevin T. Flanagan, Culver City, CA (US); Michael G. Moen, Los Angeles, CA (US); Craig D. Berry, Los Angeles, CA (US); Terrence T. Coles, Costa Mesa, CA (US)

Correspondence Address: MARTIN & FERRARO, LLP, 1557 LAKE O'PINES STREET, NE, HARTVILLE, OH, 44632, US

(73) Assignee: Intertainer, Inc.

(21) Appl. No.: 12/321,714

(22) Filed: Jan. 24, 2009

Related U.S. Application Data
(63) Continuation of application No. 09/825,758, filed on Apr. 3, 2001, now abandoned.
(60) Provisional application No. 60/255,542, filed on Dec. 14, 2000.

(51) Int. Cl. G06Q 30/00; G06Q 90/00

(52) U.S. Cl. 705/14

(57) ABSTRACT

The present invention delivers interstitial media content, such as advertisements during a user's navigation of an Internet protocol-based product, for example, a graphical user interface. The present invention may display advertisement content positioned within a web page or may display a full screen advertisement before a new web page is presented. As an interstitial advertisement, the advertisement appears between web page requests such that when a user action requests a new page, the present invention can launch an ad before displaying the requested content. The ads are preferably non-interruptible, such that the user cannot fast-forward or skip the advertisement. A preferred method detects a web page address request and delivers advertising content in an Internet protocol format to the user independently of any code associated with the requested web address. The invention may also deliver ads only after a specified time delay has elapsed, thus regulating the frequency of advertisements independent of the user's movement through the Internet protocol-based product. In another preferred embodiment, the invention may also deliver ads only after a specified number of address changes have been detected. An additional preferred embodiment may also deliver an advertisement unrelated to whether a user makes a web page request.

The present application is a continuation of U.S. application Ser. No. 09/825,758, filed Apr. 3, 2001; which claims the benefit of U.S. Provisional Application No. 60/255,542, filed Dec. 14, 2000; all of which is incorporated herein by reference.

### FIELD OF THE INVENTION

The present invention relates to Internet protocol-based advertising to a visual display adapted to display a user interface.

### BACKGROUND

With the emergence of the Internet and other digital communication channels, many companies are offering their products and services to consumers electronically. For example, content, such as music, videos, and literary works, is now offered over the Internet using various forms of electronic delivery (e.g., streaming and digital downloads). Traditionally, content companies have relied on advertisers to generate at least a portion of their revenue, since advertisers will pay to have their advertisements served to a targeted group of consumers (e.g., football fans). In the digital world, companies continue to rely on advertisements in a variety of formats (e.g., banner advertisements) to generate revenue and offer valued-added services to their customers. These advertisements are often associated with content a user requests online (e.g., travel information).

Advertisements are sometimes pre-pended to other content requested by the user either by directly encoding the advertisement content to the requested content (as in the case of audio and video media) or by packaging an advertisement media file and a requested content file together into a play list file. These methods require that a user request content, and that the advertisement is attached to the content that was requested. The advertisement delivered with the requested content in these methods are of the same media type, for example, a JPEG-encoded ad delivered with JPEG-encoded content, or a video ad delivered with video content.

Another method launches pop-up windows of advertisement content when new pages are requested. However, in that model, the advertisement is text, Shockwave™, Flash™ (Shockwave™ and Flash™ are trademarks of Macromedia, Inc., 600 Townsend Street, San Francisco, Calif. 94103), or image-based, and always appears when the page is requested. The ad content may be different each time the page is loaded, but each time the page is loaded, an ad will show. Therefore, any advertisements shown while the user is logged on-line are Universal Resource Locator (URL)-dependent. Consequently, there exists a need for Internet protocol-based advertising that does not rely on the user accessing a particular URL.

### SUMMARY OF THE INVENTION

The present invention delivers interstitial media content, such as advertisements to a visual display adapted to display a user interface for use by a user, for example, a web browser. The present invention may display advertisement content positioned within a web page or may display a full screen advertisement before a new web page is presented. As an interstitial advertisement, the advertisement appears between web page requests such that when a user action requests a new page, the present invention can launch an ad before displaying the requested content. The ads are preferably non-interruptible, meaning that the user cannot fast-forward or skip the advertisement, but must allow the advertisement to run to completion before continuing to the requested web page.

A preferred method detects a web page address request and delivers advertising content to the user independently of any code associated with the requested web address. Such code may be, for example, the web page associated with the requested web address, plus any links associated within the requested web page or tied to the requested web address. In one embodiment, the invention delivers ads only after a specified time delay has elapsed, thus regulating the frequency of advertisements independent of the user's movement through the Internet protocol-based product. In another preferred embodiment, the invention delivers ads only after a specified number of web address changes have been detected.

Another preferred embodiment delivers an advertisement unrelated to whether a user makes a web page request. For example, a user interaction (e.g., via a keyboard, voice-activated device, and/or link selection) with a visual display, such as a computer, television set, or other audio-visual device may be detected and an advertisement sent to the visual display.

The present invention greatly enhances the likelihood that a user will be present to view an advertisement delivered to the visual display.

It is to be understood that both the foregoing general description and the following detailed description are exemplary and explanatory only and are not restrictive of the invention, as claimed. The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a diagram of system components in accordance with a preferred embodiment of the invention;

FIG. 2 is a diagram of system components in accordance with another preferred embodiment of the invention;

FIG. 3 is a diagram of system components in accordance with another preferred embodiment of the invention;

FIG. 4 is a logic diagram of a preferred time-based method for delivering ads to a user;

FIG. 5 is a logic diagram of another preferred time-based method for delivering ads to a user;

FIG. 6 is a logic diagram of an address change counter-based method for delivering ads to a user; and

FIG. 7 is a logic diagram of another preferred embodiment of an address change counter-based method for delivering ads to a user.

### DESCRIPTION OF THE PREFERRED EMBODIMENTS

Reference will now be made in detail to the present preferred embodiments (exemplary embodiments) of the invention, examples of which are illustrated in the accompanying drawings. Wherever possible, the same reference numbers will be used throughout the drawings to refer to the same or like parts.

The present invention is directed to advertising that is not reliant upon the appearance of a particular content in an Internet protocol-based format. As used herein, the term “content” is meant to include all forms of viewable electronic information including, but not limited to, advertisements, promotions, music videos, motion pictures, and television programs.

The present invention is preferably used with an Internet protocol navigation aid, for example, a web browser. In instances where web browsers are used, the present invention is applicable to both browser-based video and non-video advertisements. Advertisements may include text, video, graphics, audio, HTML, or any other type of content. Preferred advertising content includes video having a high degree of visual quality, for example only, broadcast quality video and/or video quality usually associated with feature-length movies. As used herein, the phrase “broadcast quality video” is meant to include all forms of video having a visual quality at least as good as that encountered with standard cable television access.

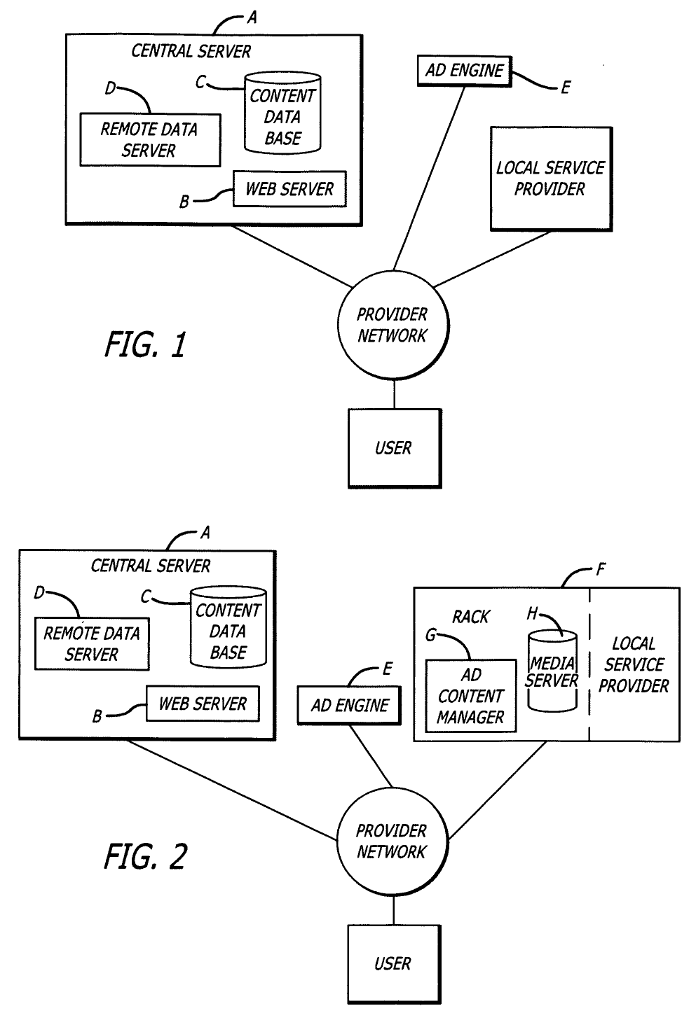

As shown in FIG. 1, a preferred embodiment of the invention includes central server A having a web server B, a content database C, and an applications server or remote data server D. Web server B and content database C interact with and store static media, such as that coded in JPEG or GIF, and low bandwidth (e.g., less than 144 Kbps) streaming media. Remote data server D acts as a gateway for a user accessing the web site and is used to launch dynamic application pages, for example, a media player to the user. Ad engine E has a separate and independent direct server for interaction with the user. Ad engine E determines user characteristics and then sends a command to web server B to deliver content specifically targeted to the characteristics of the user. User characteristics such as gender, age, geographical location, and viewing preferences may be on a user's personal profile, or if the user is part of a subscriber network, on the network database. Examples of systems and methods using targeted advertising are described in pending U.S. application Ser. No. 09/605,695, titled “Intelligent Media Targeting System and Method,” the description of which is hereby incorporated by reference herein. The role of ad engine E may be reduced or eliminated completely in situations not requiring targeted advertising. Ad engine E may exist within central server A, or could use remote data server D as its only connection to the user.

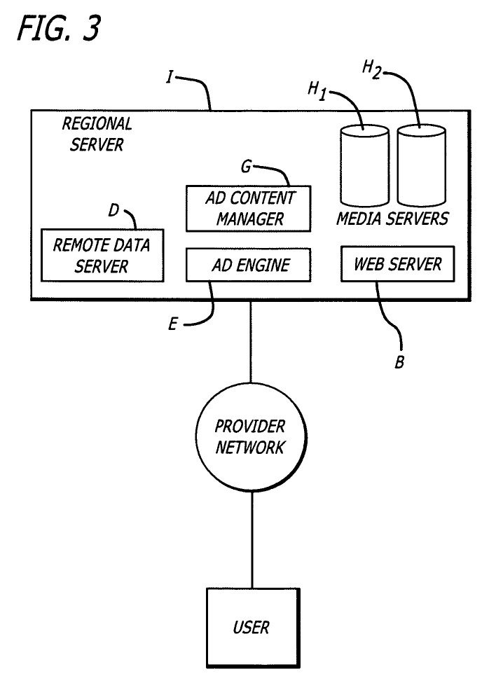

FIG. 2 shows another preferred embodiment for use with high-bandwidth (e.g., 144 Kbps or more) streaming media. Instead of storing all advertisement content on central server A, static content and low bandwidth content are stored on central server A, while high bandwidth media content is stored at rack F and ad content manager G. Rack F may be physically located in the vicinity of a local service provider in order to take advantage of a local provider's broadband network. Ad content manager G may be, for example, a known attached file server for storing content, and is in communication with media server H. In FIG. 2, ad engine E may not only provide commands to web server B to deliver ad content, but also to media server H to stream high-bandwidth advertisement content to the user. Although only one media server is illustrated, many media servers may be included to provide increased service capabilities. Further, such a plurality of media servers may be load-balanced in known ways. As mentioned with regard to FIG. 1, ad engine E need not be separate from central server A. Also, ad engine E need not be separate from rack F as illustrated in FIG. 3.

FIG. 3 shows a more localized preferred embodiment. In this embodiment, regional server I includes web server B, remote data server D, ad engine E, ad content manager G, and media servers H₁ and H₂. Region server I may be located at, for example, a local Internet service provider. By localizing certain elements of the invention, quicker response times may be achieved and storage requirements at a central location may be reduced.

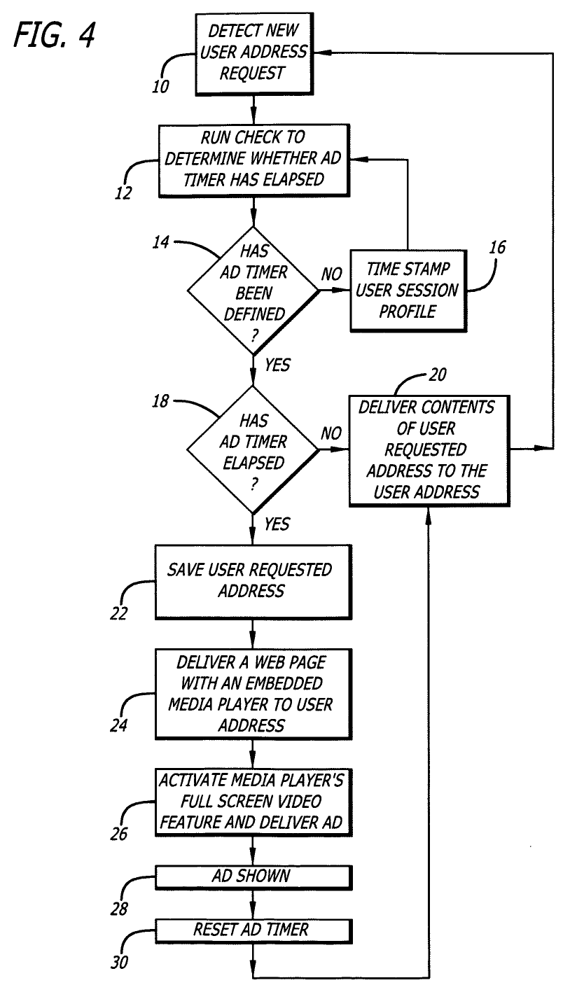

FIG. 4 shows a preferred method for delivering an ad to a user. After a user interacts with a graphic user interface, such as for example a browser, by sending an address request, remote data server D detects the new address request in step 10. As will be appreciated by those skilled in the art, various methods for detecting address requests are known and may be adapted to conform to a given set of system requirements. As used herein, an “address request” is any Internet protocol-based activity used to gain access to a web site, for example, typing a web address, transmitting a saved web address, or selecting a link. In the step 12, a check is run, preferably by remote data server D, to determine whether an ad timer has elapsed. The ad timer may be an integral part of remote data server D, an integral part of the user's local system (e.g., on the user's computer), or a connected but separate entity. Preferably, the ad timer is a program that is run in connection with remote data server D and the user's session profile maintained in a profile manager while the user is logged on.

As part of the check, first remote data server D determines if the ad timer has been defined in step 14. If no ad timer has been defined, then the user session profile (e.g., a database keeping track of user browser interactions) is time-stamped in step 16 and the check is continued to step 18 where it is determined whether the ad timer has elapsed. As will be appreciated by those skilled in the art, various methods of time stamping are known and may be adapted to conform to a given set of system requirements. In performing this check, remote data server D compares the most recent time stamp with a predetermined value. If the time interval between the time stamp and the time at which check is performed exceeds the predetermined value, then the ad timer has elapsed. For example, if the predetermined value is 20 minutes, and the time stamp is only 18 minutes old, then the ad timer has not yet elapsed. Another preferred way for checking elapsed time is to use a 24-hour clock (which can, for example, be a system clock or the viewer's hardware clock). The time stamp could, for example, show the hour, minute, and second. A predetermined value may at that point be added to the time stamp giving a target time of day. The check would then compare actual time of day as noted on the 24-hour clock against the target time. Once the target time is reached, the ad timer has elapsed. For example, if a time stamp is stamped at 12:45 p.m., and the predetermined value is 20 minutes, then the ad timer will elapse at 1:05 p.m. A check of the ad timer might be performed at 1:30 (if, for example, the user was watching a TV episode) and the elapsed ad timer will be noted. The ad timer may be defined at the beginning of a user session (i.e., upon log-on), or sometime during the user session.

If the ad timer has not elapsed, then in step 20, remote data server D delivers the contents of the user-requested address (e.g., a URL) to the user's location and awaits the next user address request. If, however, the ad timer has elapsed, then in step 22, remote data server D saves the user-requested address.

In step 24, remote data server D delivers a web page with an embedded media player to the user address. It should be understood that the aforementioned media player may be any program capable of delivering media content. Additionally, although video is a preferred media content type, other media content types may be delivered by media players adapted to deliver the particular content type. For example, Flash™ advertisements may be delivered on a Flash™ media player. Flash™ ads do not require streaming and are typically delivered as static images. The advertisement media content type may be different than the requested content type. For example, a Flash™ media ad may be delivered before or after a requested video. In step 26, the media player's full screen video feature is activated and a full screen of ad content is streamed to the media player, preferably from a media server located at rack F (FIGS. 2 and 3). While using the media player full screen mode, the media player may be programmed such that it can react to user commands that would normally shrink the video back to the original player size. For example, in a media player using Javascript to capture media player events, when the media player display mode is changed, Javascript is triggered and runs a script that checks the new display size and re-enables full screen mode if necessary. Additional Javascript may be optionally inserted to capture keyboard events (e.g., keystrokes) such that standard keyboard commands may be intercepted and stopped from affecting the media player, thus disabling selected keyboard commands. By hiding or otherwise disabling browser controls and/or functions associated with the visual display, advertisement media may be delivered uninterrupted, thus increasing the likelihood that the user will view the entire advertisement. As used herein, the phrase “visual display” is meant to include all types of video or audio-visual devices including, but not limited to, screens for computer and televisions, personal digital assistants, or any other device that provides visual content to a user.

Another exemplary preferred method of delivering a full screen of advertising while preventing or inhibiting user ability to interrupt ad delivery includes presenting the entire user interface without browser navigation buttons such that the user cannot escape when an ad is delivered. Another preferred method includes dynamically resizing and stretching the browser window such that browser buttons are positioned outside the user-accessible screen area. A further preferred method includes launching an ad in a secondary browser window that covers the original browser window. Since the secondary browser window overlays the original browser window, the user will be unable to access the original browser window until the ad has run. It will be appreciated by those skilled in the art that in the aforementioned methods, suitable programming may be adapted to present the user interface without browser navigational buttons, dynamically resize and stretch the browser window, and/or launch a secondary browser window that covers the original browser window.

It should be understood, though, that the advertisement media may also be delivered to only part of the screen. Also, a single navigation function may be included on browser window containing the ad that permits the user to either view or dismiss the ad. If the user chooses to dismiss the ad before the ad has run to completion, the user may be prevented from accessing the requested address until the ad is run.

Next, after the ad is shown in step 28, the ad timer is reset in step 30 and remote data server D delivers the contents of the user-requested address to the user's location.

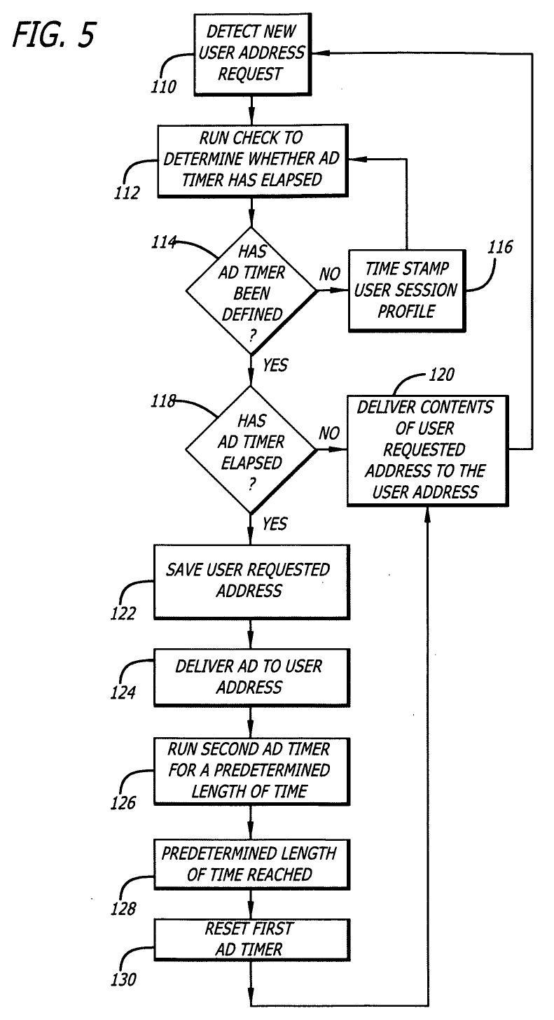

FIG. 5 describes a preferred method for use with static media advertisements. Steps 110-122 parallel steps 10-22 as described in FIG. 4. However, in step 124, web server B delivers an ad to the user's address. Next, in step 126, a second ad timer is run for a predetermined length of time. The second ad timer may function the same as the first ad timer by time-stamping the user session profile with a different time stamp recognizable to the second ad timer. The predetermined length of time may be, for example, 10 seconds. Once the predetermined length of time has been reached in step 128, remote data server D resets the first ad timer in step 130 and delivers the contents of the user-requested address to the user address thereby replacing the advertisement. It should be understood, however, that instead of two ad timers, one ad timer may be used employing two different time stamps.

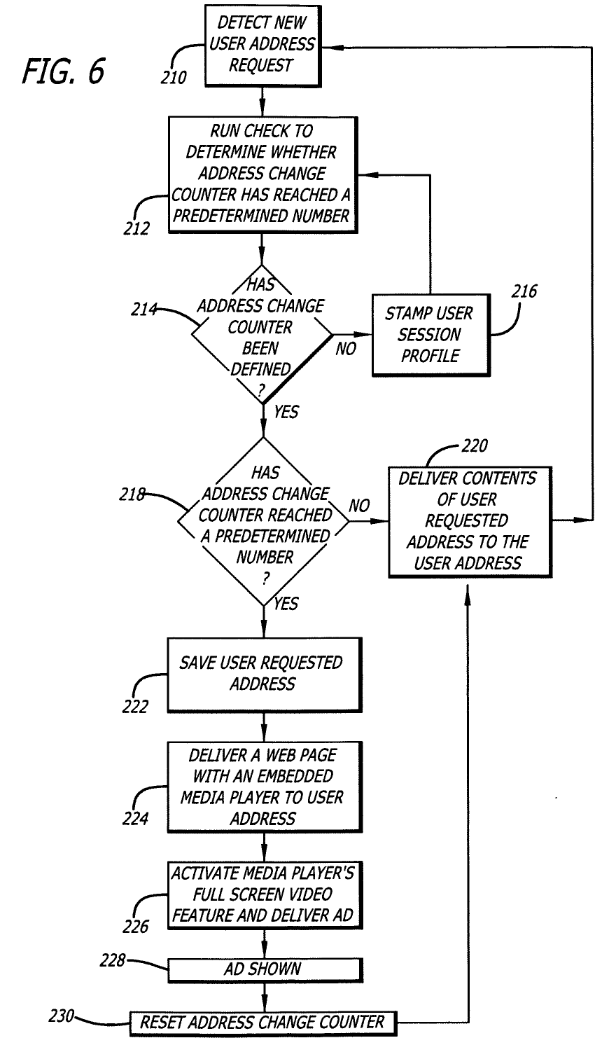

FIG. 6 describes another preferred method for delivering high-bandwidth advertisement media which uses an address change counter. In step 210, remote data server D detects a new user address (e.g., a URL) request. Thereafter, in step 212, remote data server D runs a check to determine whether the address change counter has reached a predetermined number. The address change counter tracks the number of user address requests. In running the check, in step 214, remote data server D checks to see if the address change counter has been defined. If no address change counter has been defined, then in step 216, the user's session profile is stamped and the check continues to step 218. In step 218, remote data server D determines if the address change counter has reached a predetermined number. If the address change counter has not reached a predetermined number, then in step 220 remote data server D delivers the content of the user-requested address to the user location and awaits detection of a new user address request. If the address change counter has reached a predetermined number, then in step 222, remote data server D saves the user-requested address and disables the user browser controls. In step 224, remote data server D delivers a web page with an embedded media player to the user address and thereafter, in step 226, activates the media player's full screen video feature and streams the advertisement media to the user. After the ad has been shown in step 228, remote data server D resets the address change counter in step 230 and then delivers the contents of the user-requested address to the user location. The media player may be any program capable of delivering media content.

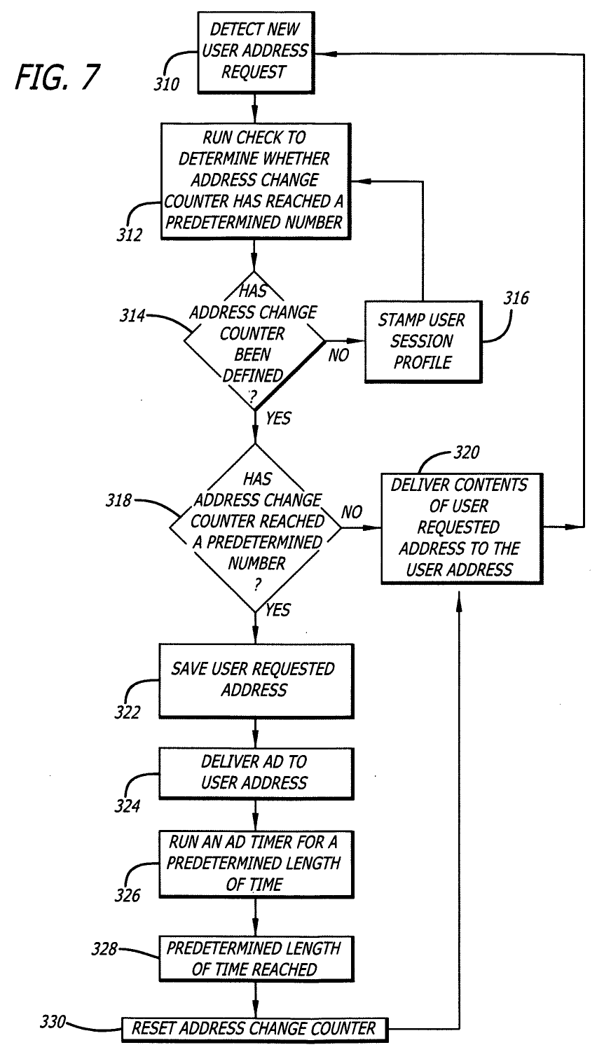

FIG. 7 shows another preferred method for delivering static media advertisements using an address change counter. Steps 310-322 parallel steps 210-222 as described in FIG. 6. However, in step 324, remote data server D delivers the advertisement to the user address. Thereafter, in step 326, an ad timer is run for a predetermined length of time. The ad timer may function, for example, by time-stamping the user session profile upon delivery of the ad. After the predetermined length of time has been reached in step 328, remote data server D resets the address change counter in step 330 and delivers the contents of the user-requested address to the user's location.

Some steps of the above embodiments may be performed by client software (e.g., Javascript) residing at the user's local system. For example, the client software may maintain a user session profile for stamping by the user's local system clock. The client software may also support a local ad timer. Additionally, the client software may effectuate an address change after ad delivery to cause user-requested content to be delivered to the user's visual display.

In another preferred embodiment of the invention, advertisements may be sent to a visual display in response to an interaction by the user with the user interface (e.g., tapping a key of a keyboard, clicking a mouse, voicing a command, initiating a remote control function, or other user interaction). For example, a user interacts with the user interface by tapping the space bar or other key on the keyboard to make a screen saver disappear on a personal computer. The keyboard interaction is detected by the present invention and an advertisement is sent to the visual display. The advertisements may be stored at a location apart from the visual display, or stored within the computer system associated with the visual display. Preferred methods of this embodiment include steps similar to those described in relation to FIGS. 4-7, except instead of detecting an address request (e.g., step 10, FIG. 4), a user interface interaction is detected. Similarly, in FIGS. 6 and 7, a user interface interaction counter would replace an address change counter.

In another preferred embodiment of the present invention, an address request is detected and advertising content is delivered to the user independently of any code associated with the requested address. As used herein, the term “code” is meant to include a set of instructions for a computer including, but not limited to, source code for web sites, Javascript, and links between web pages (e.g., hypertext links). Preferably, the request will be intercepted before it reaches its intended destination address. After intercepting the request, a server may deliver advertising content to the visual display while saving the request in a temporary memory storage area. After delivery of the advertising content, the server may forward the request onto the intended address. If desired, the processor operating the server may be programmed so that the server delivers advertising content only after a selected number of address requests have been detected. Alternatively, the time elapsed since an address request was made may be measured and the server may deliver advertising content to the visual display after a selected elapsed interval of time. As will be appreciated by those skilled in the art after reading this specification, many aspects already described in relation to using a timer are also applicable in this embodiment.

The invention as herein described may include interactive ads. For example, certain areas of the ad may include a hypertext link to another web page. Additionally, instead of delivering only one URL at a time, remote data server D can deliver a single screen with more than one URL on the screen. In instances where only one URL is displayed at a time, it is understood that more than one URL may be displayed in a series of advertisements before delivering the content of the user-requested address to the user location. An example of a system and methods using interactive video content programming is described in pending U.S. application No. 60/255,541, titled “a System and Method for Interactive Video Content Programming,” the description of which is hereby incorporated by reference herein. Advertisement content delivery may take place in an environment suitable for delivering a particular advertisement. For example, advertising content may be delivered in an Internet, intranet, cable, wireless, satellite, or a digital subscriber line (DSL) medium.

In any of the above embodiments utilizing an ad timer, the timing may commence upon a user's interaction with a user interface (e.g., a graphic user interface, or a web browser), or at any portion of a user session (e.g., the entire period of time the user's computer is operating in an Internet protocol format). For example, in some applications in which upon login, a user's computer is automatically directed to a particular web page, timing may commence when the user's computer sends an automated web address request. The timing may be fixed, for example, every five minutes, or sporadic, for example, a five minute interval, followed by a two minute interval. Timing may also be selected according to the types of content to be viewed. For example, if a user is viewing movies, the ad timer may be set at higher intervals. If a user subsequently decides to view television programs or music videos, then the ad timer may be set at lower intervals within the same user session. Further, the ad timer may be selectively disabled with respect to certain types of content. For example, it may be desirable to serve advertisements to adults, but not to children. In this instance, the ad timer may be automatically disabled whenever child-oriented content is selected by the user and enabled when other content is selected.

The invention may further include an ad reporter which reports the number of times the advertisement has been delivered, and can perform statistical analyses with the data it receives for later ad content distribution decisions. The invention as disclosed herein is also applicable in audio-only settings.

In any of the above embodiments where an address request is made with the intention of requesting video content, advertising content delivery may be paused until after the requested video has been delivered to the visual display, thus creating a commercial-free video.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for delivering advertising content from a server at a remote location to an audio-visual device having a visual display and a user interface at a user location and displaying the advertising content on the visual display to the user, said method comprising:
detecting a user session, the session commencing upon the user interacting with the user interface, the user interface including a graphical display of software presented on the visual display;
starting an ad timer upon the user making a request for user requested content by interacting with the user interface, the ad timer being set for an interval of time;
delivering the user requested content from the server to the audio-visual device at the user location;
displaying the user requested content on the visual display;
determining if the interval of time of the ad timer has elapsed when the user makes a subsequent request for user requested content by interacting with the user interface of the audio-visual device;
interrupting the delivering of the user requested content from the server to the audio-visual device at the user location and preventing the displaying of the user requested content on the visual display;
delivering the advertising content to the audio-visual device at the user location;
displaying the advertising content on the visual display if the interval of time of the ad timer has elapsed;
resetting the ad timer after the displaying of the advertising content is complete; and
continuing the delivering of the user requested content from the server to the audio-visual device at the user location and continuing the displaying of the user requested content on the visual display after the displaying of the advertising content is complete.

2. The method of claim 1, wherein the detecting of the user session commences upon an initial interaction by the user with the user interface.

3. The method of claim 1, wherein the advertising content includes streaming video.

4. The method of claim 1, further comprising suspending user interface functions during the displaying of the advertising content on the visual display.

5. The method of claim 1, wherein the continuing the delivery of the user requested content from the server to the audio-visual device at the user location occurs after a second interaction by the user with the user interface of the audio-visual device.

6. The method of claim 1, wherein the user interface is one of a web browser and a media player.

7. The method of claim 1, wherein the audio-visual device is one of a personal computer, television set, personal digital assistant, and a set-top box.

8. A method for delivering advertising content from a server at a remote location to a local system having a visual display and a user interface at a user location and displaying the advertising content on the visual display to the user, said method comprising:
detecting the user's local interaction with the user interface of the local system, the user's local interaction with the user interface being limited to the local system and not communicated to the server at the remote location;
measuring an amount of time between the user's local interactions with the user interface of the local system; and
delivering the advertising content to the local system at the user location and displaying the advertising content on the visual display after a selected elapsed interval of time if the user's local interaction with the user interface of the local system occurs during the selected elapsed interval of time.

9. The method of claim 8, wherein the measuring commences upon the user selecting content through the user interface of the local system.

10. The method of claim 8, wherein the advertising content includes streaming video.

11. The method of claim 8, further comprising suspending of the user interface functions during the displaying of the advertising content on the visual display.

12. The method of claim 8, wherein after completion of the displaying of the advertising content, the measuring of the amount of time, the delivering of the advertising content, and the displaying of the advertising content are repeated.

13. The method of claim 8, wherein the user interface is one of a web browser and a media player.

14. The method of claim 8, wherein the local system is one of a personal computer, television set, personal digital assistant, and a set-top box.

15. A method for delivering advertising content from a server at a remote location to an audio-visual device having a visual display and a user interface at a user location and displaying the advertising content on the visual display to the user, said method comprising:
time-stamping a user session profile during a user session, the user session commencing upon the user interacting with the user interface of the audio-visual device;
detecting an address for contents requested by the user;
saving the address requested by the user;
interrupting delivery of the contents of the address from the server to the audio-visual device at the user location and preventing display of the contents of the address on the visual display if a selected interval of time has elapsed since the time-stamping;
displaying the advertising content on the visual display, the displaying of the advertising content on the visual display being uninterruptible by the user for a selected period of time; and
continuing the delivery of the contents of the address requested by the user from the server to the audio-visual device at the user location and continuing the display of the contents of the address requested by the user on the visual display after the displaying of the advertising content is complete.

16. The method of claim 15, wherein the advertising content includes streaming video.

17. The method of claim 15, further comprising suspending of user interface functions during the displaying of the advertising content on the visual display.

18. The method of claim 15, further comprising delivering of video content to the audio-visual device at the user location.

19. The method of claim 15, wherein the user interface is one of a web browser and a media player.

20. The method of claim 15, wherein the audio-visual device is one of a personal computer, television set, personal digital assistant, and a set-top box.
